(19) United States
(12) Patent Application Publication
(10) Pub. No.: US 2025/0378978 A1
(43) Pub. Date: Dec. 11, 2025

(54) SENSOR DEVICE

(71) Applicant: SUMITOMO HEAVY INDUSTRIES, LTD., Tokyo (JP)

(72) Inventors: Koki INOUE, Chiba-shi (JP); Nobuyasu KUSAWAKE, Chiba-shi (JP)

(21) Appl. No.: 19/185,302

(22) Filed: Apr. 22, 2025

(30) Foreign Application Priority Data
Jun. 6, 2024 (JP) 2024-092497

(51) Int. Cl. H01F 7/02; B29C 45/76; H01F 3/10

(52) U.S. Cl. CPC H01F 7/0252; H01F 3/10; B29C 45/76; B29C 2945/76103; H01F 2003/103

(57) ABSTRACT

A sensor device includes: a sensor that performs sensing, the sensor being disposed between a surface of a target object, which is a magnetic metal member serving as a sensing target, and a magnet, and being fixed to the surface of the target object by an adsorption force due to a magnetic force generated between the magnet and the target object; and a non-magnetic cover member that is fixed to the surface of the target object in a state where a plurality of members including at least the magnet and the sensor are stored inside the cover member as stored members.

### CROSS-REFERENCE TO RELATED APPLICATIONS

This application claims priority to Japanese Patent Application No. 2024-092497, filed on Jun. 6, 2024, which is incorporated by reference herein in its entirety.

### BACKGROUND

### Technical Field

A certain embodiment of the present invention relates to a sensor device.

### Description of Related Art

A technique is known in which a sensor is disposed on a surface of a target object, which is a metal member serving as a sensing target, and a magnet is further disposed on the sensor, and an adsorption force due to a magnetic force generated between the magnet and the target object is utilized, thereby pressing the sensor against the surface of the target object to fix the sensor (for example, the related art). With such a technique, the sensor can be fixed to the surface of the target object in an aspect in which the number of components is smaller.

### SUMMARY

According to an embodiment of the present invention, there is provided a sensor device including a sensor that performs sensing, the sensor being disposed between a surface of a target object, which is a magnetic metal member serving as a sensing target, and a magnet, and being fixed to the surface of the target object by an adsorption force due to a magnetic force generated between the magnet and the target object; and a non-magnetic cover member that is fixed to the surface of the target object in a state where a plurality of members including at least the magnet and the sensor are stored inside the cover member as stored members.

Here, a yoke that increases an adsorption force due to a magnetic force may be fixed to the magnet, and the cover member may be disposed on the surface of the target object in a state where the stored members including at least the yoke, the magnet, and the sensor are stored inside the cover member.

In addition, the cover member may not be in contact with the stored members in a state where a magnetic force is not generated between an external object and the magnet.

In addition, when an attractive force due to the magnetic force generated between the external object and the magnet is larger than the adsorption force, the magnet is separated from the sensor, and a part of the stored members and an inner surface of the cover member come into contact with each other, the inner surface of the cover member may support the part of the stored members, when the attractive force is weakened, and the adsorption force due to the magnetic force generated between the magnet and the target object is larger than the attractive force, the part of the stored members may be separated from the inner surface of the cover member, and the magnet may come into contact with the sensor again by the adsorption force due to the magnetic force generated between the magnet and the target object, so that the sensor may be fixed to the surface of the target object again.

In addition, a fixing member may be further included, which is fixed so as to be wound around the surface of the target object, which has a columnar or tubular shape, in a circumferential direction and that fixes the cover member to the target object, and the fixing member may include a cover member fixation portion that fixes the cover member and a suppression wall that suppresses movement of the stored members along the surface of the target object.

In addition, a predetermined size of a gap may be formed between the cover member fixed to the cover member fixation portion and the target object.

In addition, the cover member and the fixing member may have plasticity and may have the same degree of strength against an external force.

In addition, the cover member may be made of non-magnetic stainless steel or resin.

In addition, the target object may be a tie bar of an injection molding machine, and the sensor may perform sensing of the tie bar.

### BRIEF DESCRIPTION OF THE DRAWINGS

FIG. 1 is a diagram showing an example of the configuration of a sensor device according to the present embodiment.

FIG. 2 is a view showing a state when a hammer including a magnetic metal member approaches the vicinity of the sensor device fixed to an outer peripheral surface of a tie bar.

FIG. 3 is a view showing a state when a situation shown in FIG. 2 occurs in a sensor device of the related art that does not have a cover member.

FIGS. 4A and 4B are views showing a specific example of the configuration of the fixing member of FIG. 1.

FIGS. 5A and 5B are views showing a specific example of the configuration of the cover member of FIG. 1.

FIGS. 6A and 6B are views showing a specific example in a state where the sensor device is fixed to the outer peripheral surface of the tie bar.

### DETAILED DESCRIPTION

However, since the sensor is fixed to the target object by utilizing an adsorption force due to a magnetic force generated between the magnet and the target object, when a magnetic external object approaches the sensor, the magnet may be affected and separated from the sensor. In this case, the adsorption force due to the magnetic force is weakened, and the sensor is separated from the target object, so that the sensing may not be performed.

It is desirable to suppress separation of a sensor, which is fixed to a sensing target object by an adsorption force due to a magnetic force generated between a magnet and the sensing target object, from the sensing target object.

Hereinafter, embodiments of the present invention will be described in detail with reference to the accompanying drawings.

### Configuration of Sensor Device

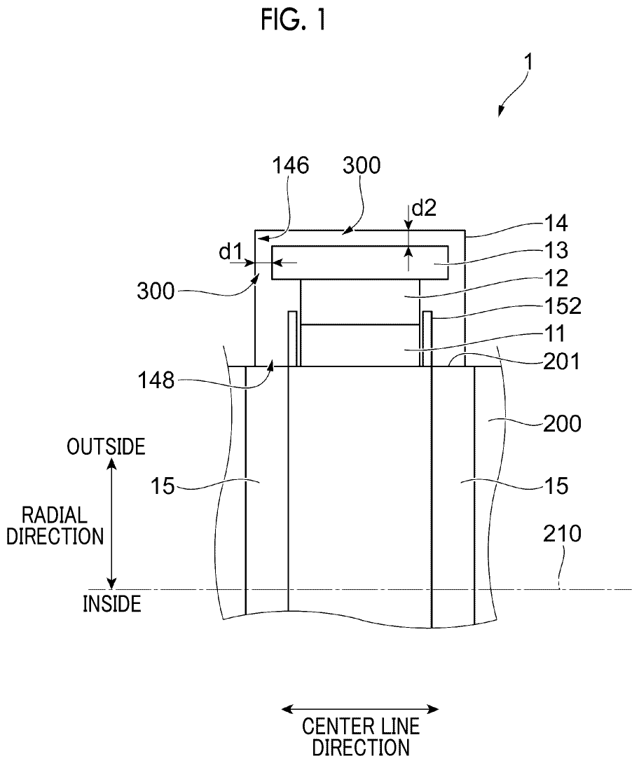

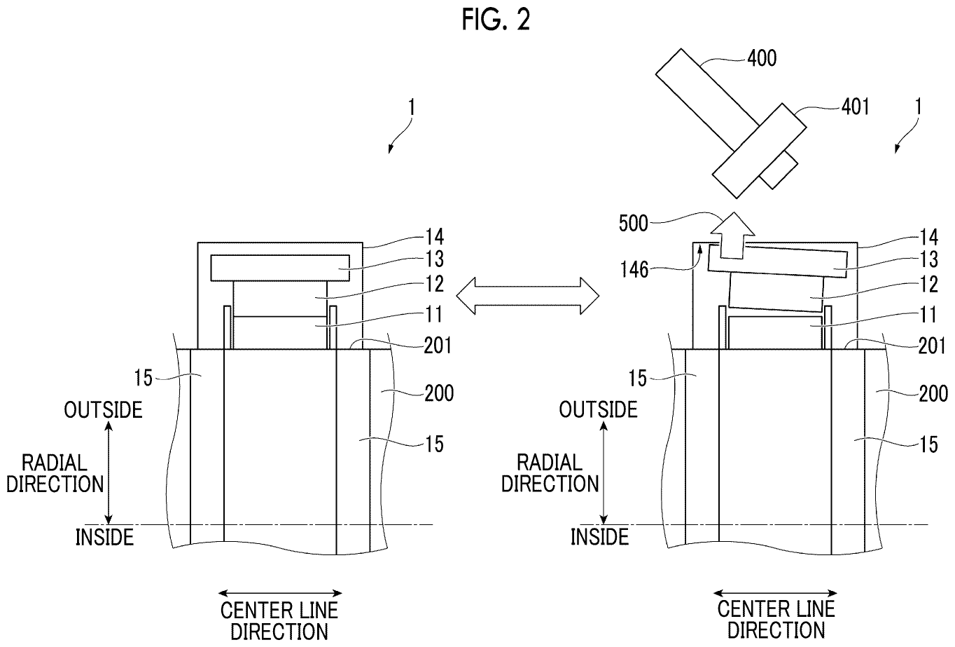

FIG. 1 is a diagram showing an example of the configuration of a sensor device 1 according to the present embodiment. In FIGS. 1 and 2 to be described below, a state where a part of a cover member 14 and a part of a fixing member 15 to be described below are transparent is shown to facilitate understanding of a positional relationship of stored members stored inside the cover member 14 to be described below.

The sensor device 1 is a device that performs sensing on a tie bar 200 of an injection molding machine. The tie bar 200 as a target object serving as a sensing target by the sensor device 1 is a columnar and magnetic metal member, and is capable of guiding an opening and closing operation of a mold of the injection molding machine and capable of tightening the mold.

Here, a left-right direction in FIG. 1 indicates a direction in which a center line 210 of the tie bar 200 extends (hereinafter, may be simply referred to as a “center line direction”). In addition, an up-down direction in FIG. 1 indicates a radial direction of the tie bar 200. Hereinafter, a center line side of the tie bar 200 in the radial direction is referred to as an “inside of the tie bar 200 in the radial direction”, and an opposite side is referred to as an “outside of the tie bar 200 in the radial direction”.

### Sensor

The sensor device 1 has a sensor 11 disposed on an outer peripheral surface 201 of the tie bar 200 and a magnet 12 disposed to sandwich the sensor 11 between the magnet 12 and the tie bar 200. The sensor 11 is a sensor having a substantially quadrangular prismatic casing. The sensor 11 is fixed to the outer peripheral surface 201 of the tie bar 200 to be pressed from the outside of the tie bar 200 toward the inside thereof in the radial direction by an adsorption force due to a magnetic force generated between the magnet 12 and the tie bar 200. The sensor 11 can be pressed against the outer peripheral surface 201 and brought into close contact with the outer peripheral surface 201 to further increase the accuracy of sensing. The sensing function of the sensor 11 is not particularly limited. For example, the sensor 11 may perform sensing for the purpose of measuring the distortion of the tie bar 200.

### Magnet

The magnet 12 is a substantially quadrangular prismatic magnet, and is fixed to the outer peripheral surface 201 of the tie bar 200 to press the sensor 11 against the outer peripheral surface 201 of the tie bar 200 by means of an adsorption force due to a magnetic force generated between the magnet 12 and the tie bar 200. The magnet 12 is made of a permanent magnet or the like. The size of the magnet 12 is not particularly limited as long as the magnet 12 can be stored in the cover member 14 to be described below. In the present embodiment, the length of the magnet 12 in the center line direction and the length of the sensor 11 in the center line direction are configured to be the same or substantially the same. In addition, although not shown in FIG. 1, the length of each of the magnet 12 and the sensor 11 in the direction from the front side of the drawing to the back side of the drawing is also configured to be the same or substantially the same.

### Yoke

In addition, the sensor device 1 has a yoke 13 for increasing an adsorption force due to the magnetic force of the magnet 12. The yoke 13 is a magnetic metal member, and is a member that is disposed outside the magnet 12 in the radial direction of the tie bar 200 to increase the adsorption force of the magnet 12 to the tie bar 200. The yoke 13 is joined to the magnet 12. A method of joining the yoke 13 to the magnet 12 is not particularly limited, and, for example, the yoke 13 is joined to the magnet 12 by using a method such as adhesion. The size of the yoke 13 is not particularly limited as long as the yoke 13 can be stored inside the cover member 14 to be described below. In the present embodiment, the length of the yoke 13 in the center line direction is configured to be longer than the length of the magnet 12 in the center line direction. In addition, although not shown in FIG. 1, the length of the yoke 13 in the direction from the front side of the drawing to the back side of the drawing is also configured to be longer than the length of the magnet 12 in the direction from the front side of the drawing to the back side of the drawing.

Although not shown, a general yoke has a box shape or a “U” shape, and is disposed to surround a magnet disposed on a surface of a magnetic metal member from the outside. In this case, an end portion (edge portion) of the yoke is fixed in contact with or in proximity to the surface of the magnetic metal member. Accordingly, since a magnetic flux flows from the end portion of the yoke toward the magnetic metal member, the adsorption force of the magnet to the magnetic metal member can be increased. In contrast, the yoke 13 according to the present embodiment is different from a general yoke in that the end portion is not in contact with or in proximity to the tie bar 200 (magnetic metal member), but has an effect of increasing the adsorption force of the magnet 12 to the tie bar 200. This is because, in the present embodiment, both the cover member 14 surrounding the yoke 13 and the fixing member 15 are non-magnetic members and do not allow the magnetic flux to flow. Accordingly, even when the end portion of the yoke 13 is not in contact with or in proximity to the tie bar 200, the magnetic flux flows from the end portion of the yoke 13 to the tie bar 200. As a result, the adsorption force of the magnet 12 to the tie bar 200 can be increased.

In addition, in the present embodiment, the shape of the yoke 13 is a quadrangular shape. However, the shape of the yoke 13 is not particularly limited. In addition, as described above, the end portion of the yoke 13 is not in contact with the tie bar 200, but the end portion of the yoke 13 may be in contact with the tie bar 200. In addition, the yoke 13 is joined to the magnet 12, but the yoke 13 may be configured not to be joined to the magnet 12. In this case, for example, the cover member 14 may be configured to press the yoke 13 from the outside of the tie bar 200 toward the inside thereof in the radial direction. The yoke 13 is not an essential component of the sensor device 1, but the adsorption force due to the magnetic force of the magnet 12 is increased by having the yoke 13. As a result, the stability of the sensor 11 fixed to the outer peripheral surface 201 of the tie bar 200 is improved.

### Cover Member

In addition, the sensor device 1 has the cover member 14 for protecting the sensor 11, the magnet 12, and the yoke 13 from an external force or the like and for suppressing the separation of the sensor 11 from the tie bar 200. The cover member 14 is a box-shaped and non-magnetic member having an opening portion 148, and stores the sensor 11, the magnet 12, and the yoke 13 therein as the stored members. The cover member 14 is fixed to the outer peripheral surface 201 of the tie bar 200 in a state where the stored members are stored. The cover member 14 is made of, for example, non-magnetic stainless steel, plastic, rubber, silicon, urethane, or the like. In the present embodiment, the material of the cover member 14 is non-magnetic stainless steel, and the thickness of the cover member 14 is about 1 mm. The cover member 14 has a role of buffering an external force to protect the stored members.

The cover member 14 is not in contact with a stored member in a state where a magnetic force is not generated between the magnet 12 stored inside the cover member 14 as the stored member and an object present outside. For example, a slight gap is formed in a portion where an inner surface 146 of the cover member 14 and a stored member are closest to each other. Specifically, a gap 300 is formed between the yoke 13, which is a stored member closest to the inner surface 146, and the inner surface 146. Therefore, even when a strong external force is applied to the cover member 14 to such a degree that a portion of the cover member 14 is depressed, the stored members including the yoke 13 are protected as long as the depression does not fill the gap 300.

From the viewpoint of protecting the stored members including the yoke 13, the larger the gap 300 formed between the inner surface 146 of the cover member 14 and the stored members, the easier it is to protect the stored members. However, depending on the situation in which the sensor device 1 is placed, the magnet 12 may be separated from the sensor 11. In this case, when the gap 300 is too wide, the magnet 12 separated from the sensor 11 may completely fall off inside the cover member 14. When the magnet 12 completely falls off, sensing cannot be performed. Thus, repair work by a worker is required. That is, it is necessary to perform work for returning the sensor 11 to a state where the sensor 11 is fixed so as to be pressed against the outer peripheral surface 201 of the tie bar 200 by the adsorption force due to the magnetic force generated between the magnet 12 and the tie bar 200. For this reason, it is preferable that the gap 300 is formed such that a distance d1 between the inner surface 146 of the cover member 14 and the yoke 13 in the center line direction and a distance d2 between the inner surface 146 of the cover member 14 and the yoke 13 in the radial direction of the tie bar 200 are each approximately 3 mm.

### Fixing Member

In addition, the sensor device 1 has the fixing member 15 for fixing the cover member 14 to the tie bar 200. The fixing member 15 is an annular metal member also referred to as a bracket, and is fixed so as to be wound around the outer peripheral surface 201 of the tie bar 200 having a columnar tubular shape in the circumferential direction. Both the cover member 14 and the fixing member 15 have plasticity, and have the same degree of strength against an external force. Therefore, when an external force is applied to the cover member 14, depending on the magnitude of the external force, the cover member 14 and the fixing member 15 may be deformed, or a dent may remain in the cover member 14. Accordingly, a worker can determine what kind of external force is applied to the cover member 14 and the fixing member 15 afterwards based on the state of the cover member 14 and the fixing member 15.

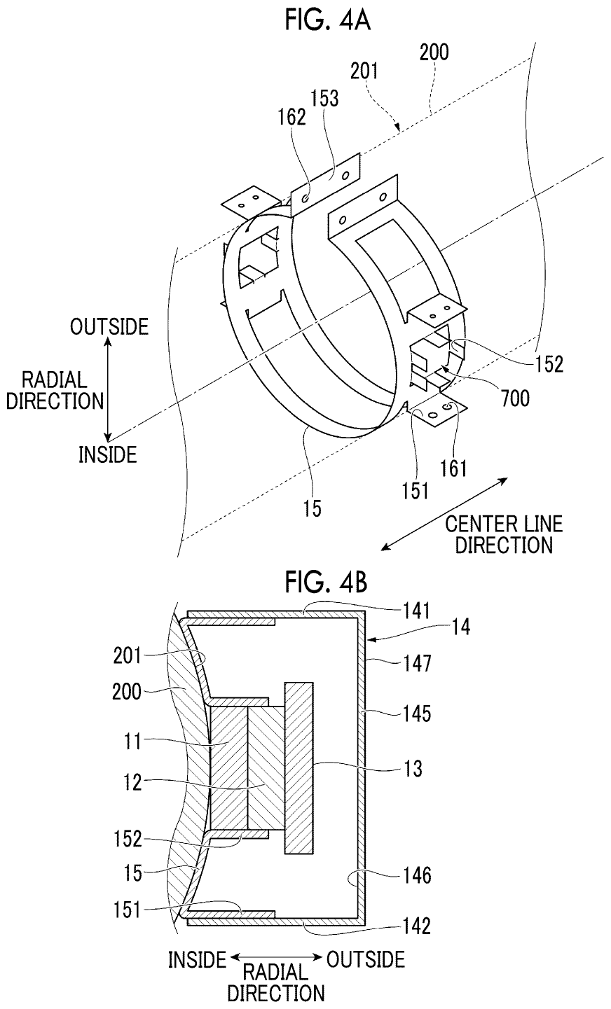

The fixing member 15 includes a cover member fixation portion 151 for fixing the cover member 14 and a suppression wall 152 for suppressing the movement of the stored members on the outer peripheral surface 201 of the tie bar 200. A specific example of the configuration of the fixing member 15 including the cover member fixation portion 151 and the suppression wall 152 will be described below with reference to FIGS. 4A and 4B.

Here, an example of a situation where the magnet 12 is separated from the sensor 11 will be described.

FIG. 2 is a view showing a state where a hammer 400 including a magnetic metal member 401 is approaching the vicinity of the sensor device 1 fixed to the outer peripheral surface 201 of the tie bar 200.

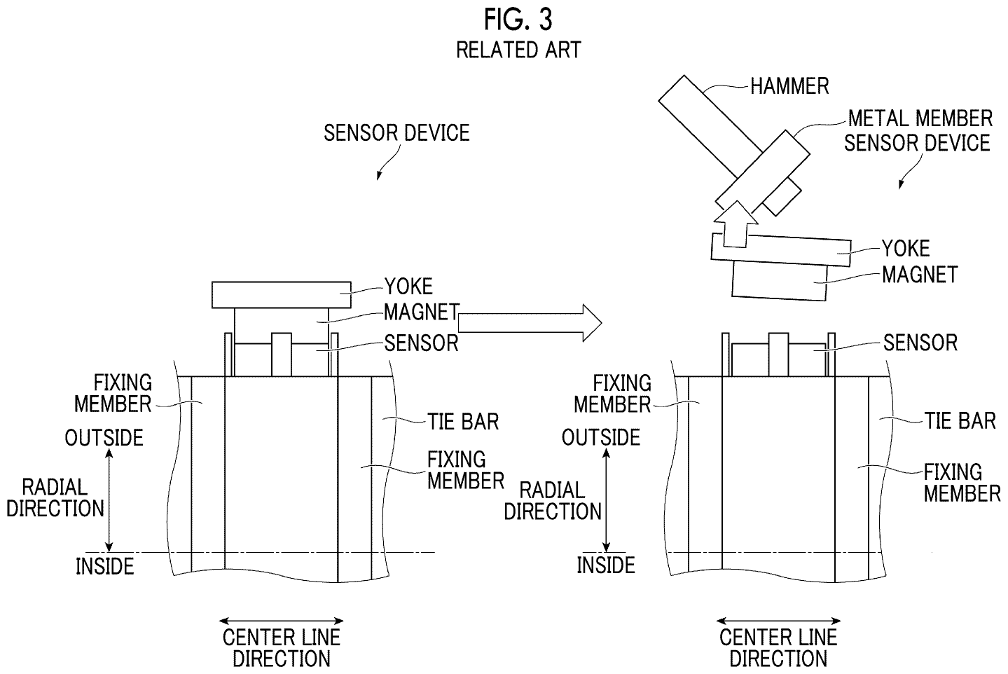

FIG. 3 is a view showing a state when a situation shown in FIG. 2 has occurred in a sensor device of the related art that does not have the cover member 14.

Initially, the sensor device 1 is in a state as shown in a left view of FIG. 2. That is, the sensor 11 is fixed so as to be pressed against the outer peripheral surface 201 of the tie bar 200 by an adsorption force due to a magnetic force generated between the magnet 12 and the tie bar 200.

For example, a worker (not shown) approaches the sensor device 1 while holding the hammer 400. The hammer 400 includes the magnetic metal member 401. In this case, a magnetic force is generated between the metal member 401 of the hammer 400 and the magnet 12 of the sensor device 1, generating an attractive force. As a result, as shown in a right view of FIG. 2, the magnet 12 and the yoke 13 may be pulled in the direction of an arrow 500, and the magnet 12 may be separated from the sensor 11. In this state, the attractive force due to the magnetic force generated between the metal member 401 of the hammer 400 and the magnet 12 of the sensor device 1 is larger than the adsorption force due to the magnetic force generated between the magnet 12 and the tie bar 200.

As described above, the sensor device 1 has the cover member 14 that internally stores and protects the stored members including the magnet 12 and the yoke 13. Therefore, even when the magnet 12 is separated from the sensor 11, as shown in the right view of FIG. 2, a part of the yoke 13 stops by coming into contact with the inner surface 146 of the cover member 14. That is, the inner surface 146 of the cover member 14 supports the yoke 13 and the magnet 12. As a result, the yoke 13 and the magnet 12 are prevented from completely falling off and being unable to return to an initial state shown in the left view of FIG. 2. FIG. 3 shows, as a comparative example, an example in which the cover member 14 is not provided in the configuration of the sensor device 1 described above. As shown in a right view of FIG. 3, when the hammer approaches the sensor device without the cover member 14, the yoke and the magnet completely fall off and are attracted to the metal member of the hammer. In this case, the adsorption force of the magnet is weakened, and as a result, the sensor is separated from the tie bar.

Returning to FIG. 2, it is assumed that a worker holding the hammer 400 moves away from the sensor device 1. As a result, the attractive force due to the magnetic force generated between the metal member 401 of the hammer 400 and the magnet 12 of the sensor device 1 is gradually weakened. Accordingly, the attractive force due to the magnetic force generated between the magnet 12 and the tie bar 200 is larger than the attractive force due to the magnetic force generated between the metal member 401 and the magnet 12. As a result, the sensor 11 is naturally returned to a state where the sensor 11 is fixed so as to be pressed against the outer peripheral surface 201 of the tie bar 200 by the adsorption force due to the magnetic force generated between the magnet 12 and the tie bar 200. That is, a return is made to the initial state shown in the left view of FIG. 2.

### Specific Example

FIGS. 4A and 4B are views showing a specific example of the configuration of the fixing member 15 of FIG. 1. FIG. 4A shows a state where the fixing member 15 is fixed so as to be wound around the outer peripheral surface 201 of the tie bar 200. FIG. 4B is a sectional view of a state where the cover member 14 is fixed to the fixing member 15 and the stored members are stored inside the cover member 14.

As described above, the fixing member 15 is a member for fixing the cover member 14 (refer to FIG. 1) to the outer peripheral surface 201 of the tie bar 200. As shown in FIGS. 4A and 4B, the fixing member 15 includes the cover member fixation portion 151 for fixing the cover member 14, the suppression wall 152 for suppressing the movement of the stored members on the outer peripheral surface 201 of the tie bar 200, and a fixing member fixation portion 153 for fixing the fixing member 15 to the tie bar 200. FIGS. 4A and 4B show a specific example of the cover member fixation portion 151, the suppression wall 152, and the fixing member fixation portion 153, which are each formed on the outer peripheral surface 201 of the tie bar 200.

The cover member fixation portion 151 is a quadrangular plate material formed by folding up a part of the fixing member 15 in a direction away from the outer peripheral surface 201 of the tie bar 200. The cover member fixation portion 151 is provided with two screw holes 161 for fixing the cover member 14 with screws (not shown) so as to be aligned in the center line direction.

The suppression wall 152 is a quadrangular plate material formed by folding up a part of the fixing member 15 in a direction away from the outer peripheral surface 201 of the tie bar 200. The suppression wall 152 is a member formed such that the stored members do not move along the outer peripheral surface 201 of the tie bar 200. The suppression wall 152 is formed to surround the four sides of a region 700 in which the stored members are disposed. In the example of FIG. 4A, two suppression walls 152 for suppressing the movement of the stored members on the outer peripheral surface 201 of the tie bar 200 in the circumferential direction are formed. In addition, three suppression walls 152 for suppressing the movement of the stored members on the outer peripheral surface 201 of the tie bar 200 in the center line direction are formed. Accordingly, the movement of the stored members disposed in the region 700 along the outer peripheral surface 201 of the tie bar 200 is suppressed.

The fixing member fixation portion 153 is a quadrangular plate material formed by folding up both end portions of the fixing member 15 in a direction away from the outer peripheral surface 201 of the tie bar 200. As shown in FIG. 4A, a fixing member fixation portion 153 for fixing the fixing member 15 to the tie bar 200 is formed at each of both end portions of the fixing member 15. The fixing member fixation portion 153 is provided with two screw holes 162 for fixing the fixing member 15 to the tie bar 200 with screws (not shown) so as to be aligned in the center line direction.

With the fixing member 15 having such a configuration, the sensor device 1 can be fixed to any position on the outer peripheral surface 201 of the tie bar 200. For example, in a case where a top side of the tie bar 200 in a top-to-bottom direction is set to a 12 o'clock direction, the sensor device 1 can be fixed to the outer peripheral surface 201 of the tie bar 200 in the 12 o'clock direction, and the sensor device 1 can be fixed to the outer peripheral surface 201 of the tie bar 200 in a 6 o'clock direction on the opposite side. In addition, the sensor device 1 can be fixed to the outer peripheral surface 201 of the tie bar 200 in a 3 o'clock direction, and the sensor device 1 can be fixed to the outer peripheral surface 201 in a 9 o'clock direction on the opposite side.

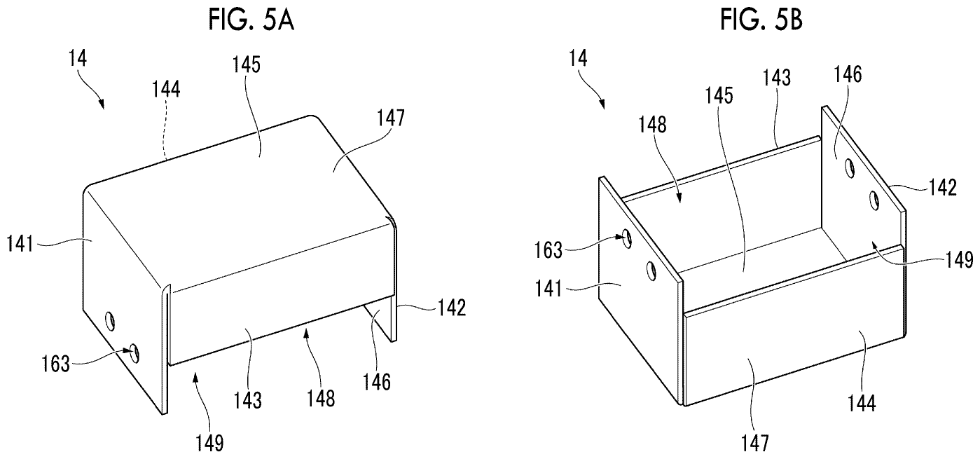

FIGS. 5A and 5B are views showing a specific example of the configuration of the cover member 14 of FIG. 1.

As shown in FIG. 1 described above, the cover member 14 is a member that is fixed to the fixing member 15 on the outer peripheral surface 201 of the tie bar 200 in a state where the sensor 11, the magnet 12, and the yoke 13, which are the stored members, are stored inside the cover member 14. As shown in FIGS. 5A and 5B, the cover member 14 includes five walls 141 to 145 and an opening portion 148. In addition, the cover member 14 is provided with an inner surface 146 and an outer surface 147.

In the present embodiment, the walls 141 to 145 are formed by giving folds to predetermined positions of a single metal plate processed into a predetermined shape and folding up the portions corresponding to walls 141 to 144 relative to a portion that becomes the wall 145, respectively. The method for producing the cover member 14 is not limited to this method. For example, a box shape may be formed by joining the end portions of the substantially quadrangular metal plate, which become the five walls, by welding or the like.

Two screw holes 163 are provided in the walls 141 and 142 so as to be aligned with each other. The screw holes 163, and the screw holes 161 of the cover member fixation portion 151 of the fixing member 15 shown in FIGS. 4A and 4B described above, are combined with each other, and the cover member 14 is fixed to the fixing member 15 by passing screws (not shown) therethrough.

The walls 143 and 144 are configured such that the back height when the walls 143 and 144 are folded up with respect to the wall 145 is lower than the back height of the walls 141 and 142. Accordingly, as shown in FIGS. 5A and 5B, a quadrangular notch portion 149 is formed in the entire shape of the cover member 14. The notch portion 149 functions as a gap for passing various cables extending from the sensor 11 of the sensor device 1 fixed to the outer peripheral surface 201 of the tie bar 200 to the outside.

In addition, the difference in back height between the walls 141 and 142 and the walls 143 and 144 is not particularly limited. The notch portion 149 may be formed to provide a gap through which various cables pass while maintaining the function of protecting the stored members, such as suppressing accidental entering of a tool or the like into the cover member 14. For example, the back height of the walls 143 and 144 may be configured to be approximately 5 mm lower than the back height of the walls 141 and 142.

In addition, the shape of the notch portion 149 is not limited to a quadrangular shape. For example, the shape of the notch portion 149 may be made to match the curved surface shape of the outer peripheral surface 201 of the tie bar 200. Accordingly, since the gap formed between the cover member 14 and the outer peripheral surface 201 of the tie bar 200 can be narrowed, the function of protecting the stored members can be enhanced. However, the size of the diameter of the tie bar 200 is variable. For this reason, as in the present embodiment, it is preferable to form the shape of the notch portion 149 into a quadrangular shape such that a gap formed between the cover member 14 and the outer peripheral surface 201 of the tie bar 200 has a margin. Accordingly, the versatility of the sensor device 1 can be improved. In addition, since the amount of processing required to form a curved surface is reduced, it is possible to reduce the manufacturing cost of the cover member 14.

The wall 145 is a wall disposed on the outermost side in the radial direction of the tie bar 200 when the sensor device 1 is fixed to the fixing member 15 in FIGS. 4A and 4B described above. As described above, the cover member 14 according to the present embodiment is formed by folding up the walls 141 to 144 with respect to the wall 145. For this reason, as shown in FIG. 5A, a curved surface is formed at a boundary portion (corner portion) between the wall 145 and each of the walls 141 to 144. As a result, for example, the feeling when a worker touches the corner portion of the cover member 14 becomes smooth as compared to a case where the walls 141 to 145 are simply joined by welding or the like to the five quadrangular metal plates. Therefore, the present configuration is also suitable in terms of safety.

In addition, the walls 141 to 145 are configured such that the outer surfaces 147 thereof are flat surfaces. In addition, in the present embodiment, the cover member 14 is made of a plastic material as described above. Therefore, for example, in a case where an external force is applied to the walls 141 to 145 to cause deformation or to leave a dent, a worker can also determine what kind of external force has been applied to the cover member 14 afterwards based on that state.

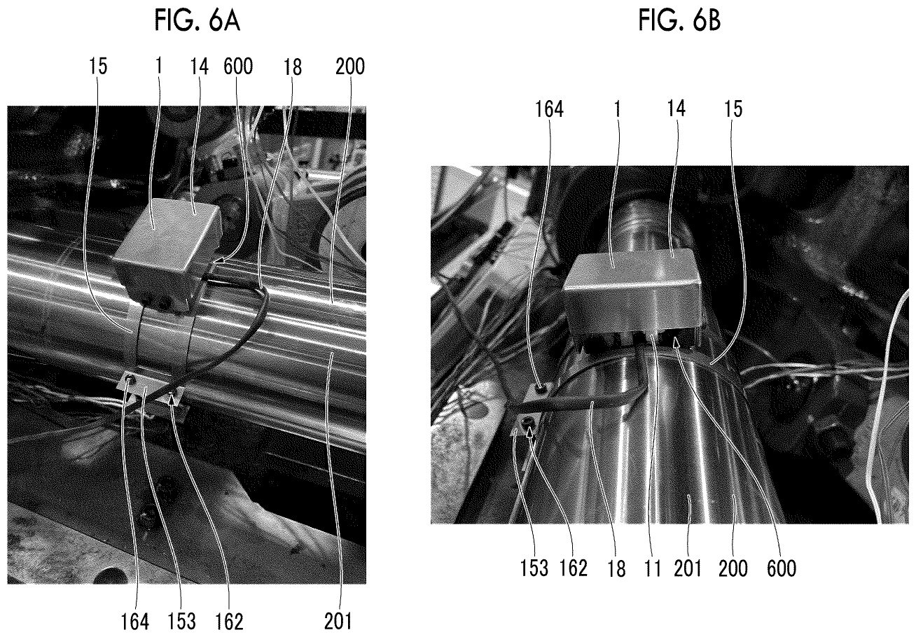

FIGS. 6A and 6B are views showing a specific example of a state where the sensor device 1 is fixed to the outer peripheral surface 201 of the tie bar 200. FIG. 6A shows a state where the sensor device 1 is fixed to the outer peripheral surface 201 of the tie bar 200 when viewed in the radial direction of the tie bar 200. FIG. 6B shows a state where the sensor device 1 is fixed to the outer peripheral surface 201 of the tie bar 200 when viewed from the center line direction of the tie bar 200.

The sensor device 1 is fixed by winding the fixing member 15 around the outer peripheral surface 201 of the tie bar 200 in the circumferential direction and tightening a screw 164 through the screw hole 162 provided in the fixing member fixation portion 153 of the fixing member 15. A cable bundle 18 in which a power supply cable, a communication cable, or the like is stored is connected to the sensor 11 stored inside the cover member 14 of the sensor device 1. The cable bundle 18 connected to the sensor 11 extends outward through a gap 600 formed by the notch portion 149 of the cover member 14.

As shown in FIGS. 6A and 6B, various members and devices are disposed in the vicinity of the sensor device 1 fixed to the outer peripheral surface 201 of the tie bar 200 in terms of the structure of the injection molding machine. Many metal members that can generate a magnetic force between the magnet 12 of the sensor device 1 are present in the members or devices disposed in the vicinity of the sensor device 1. For this reason, by fixing the sensor device 1 having the cover member 14 to the outer peripheral surface 201 of the tie bar 200, even when a situation as shown in FIG. 2 described above occurs, the cover member 14 plays a role of suppressing the complete falling-off of the magnet 12 from the sensor 11. As a result, the separation of the sensor 11 from the outer peripheral surface 201 of the tie bar 200 is suppressed. Moreover, even when an external force is applied to the sensor device 1, the cover member 14 plays a role of protecting the stored members stored inside the cover member 14.

Summarizing the above, the sensor device to which the present embodiment is applied may have the following configuration and can take various embodiments.

That is, a sensor device 1 according to the present embodiment is a sensor device having a sensor 11 that performs sensing, the sensor 11 disposed between an outer peripheral surface 201 of a tie bar 200 as a target object, which is a magnetic metal member serving as a sensing target, and a magnet 12 and fixed to the outer peripheral surface 201 of the tie bar 200 by an adsorption force due to a magnetic force generated between the magnet 12 and the tie bar 200 to sense the tie bar 200, and a non-magnetic cover member 14 that is fixed to the outer peripheral surface 201 of the tie bar 200 in a state where a plurality of members including at least the magnet 12 and the sensor 11 are stored inside the cover member 14 as stored members.

Accordingly, even when the magnet 12 is separated from the sensor 11 as a magnetic external object approaches the sensor device 1, the stored members including the separated magnet 12 can be held inside the cover member 14. Therefore, a state where a magnetic force is generated between the magnet 12 and the tie bar 200 can be maintained. Then, when the magnetic external object moves away from the sensor device 1, a force that causes the magnetic external object to return to its original state acts, and the state before the separation is restored. As a result, the separation of the sensor 11 fixed to the tie bar 200 from the tie bar 200 by the attractive force due to the magnetic force generated between the magnet 12 and the tie bar 200 can be suppressed.

Here, a yoke 13 that increases an adsorption force due to a magnetic force may be fixed to the magnet 12, and the cover member 14 may be disposed on the outer peripheral surface 201 of the tie bar 200 in a state where the stored members including at least the yoke 13, the magnet 12, and the sensor 11 are stored inside the cover member 14.

Accordingly, the stability of the sensor 11 fixed to the outer peripheral surface 201 of the tie bar 200 is improved. As a result, the separation of the sensor 11 fixed to the tie bar 200 from the tie bar 200 by the attractive force due to the magnetic force generated between the magnet 12 and the tie bar 200 can be further suppressed.

In addition, the cover member 14 may not be in contact with the stored members in a state where a magnetic force is not generated between an external object (for example, a hammer 400 in FIG. 2) and the magnet 12.

Accordingly, even when a strong external force is applied to the cover member 14 such that a part of the cover member 14 is depressed, the depression can protect the stored members including the yoke 13 as long as the dent does not fill the gap 300.

In addition, when an attractive force due to the magnetic force generated between the external object and the magnet 12 is larger than the adsorption force due to the magnetic force generated between the magnet 12 and the tie bar 200, the magnet 12 is separated from the sensor 11, and a part (for example, the yoke 13) of the stored members and an inner surface 146 of the cover member 14 come into contact with each other, the inner surface 146 of the cover member 14 may support the part of the stored members, when the attractive force due to the magnetic force generated between the external object and the magnet 12 is weakened, and the adsorption force due to the magnetic force generated between the magnet 12 and the tie bar 200 is larger than the attractive force, a part of the stored members may be separated from the inner surface of the cover member 14, and the magnet 12 may come into contact with the sensor 11 again by the adsorption force due to the magnetic force generated between the magnet 12 and the tie bar 200, so that the sensor 11 is fixed to an outer peripheral surface 201 of the tie bar 200 again.

Accordingly, even when the magnet 12 is separated from the sensor 11 as a magnetic external object approaches the sensor device 1, the stored members including the separated magnet 12 can be held inside the cover member 14. Therefore, a state where a magnetic force is generated between the magnet 12 and the tie bar 200 can be maintained. Then, when the magnetic external object moves away from the sensor device 1, a force that causes the magnetic external object to return to its original state acts, and the state before the separation is restored. As a result, the separation of the sensor 11 fixed to the tie bar 200 from the tie bar 200 by the attractive force due to the magnetic force generated between the magnet 12 and the tie bar 200 can be suppressed.

In addition, a fixing member 15 may be further included, which is fixed so as to be wound around the outer peripheral surface 201 of the tie bar 200 as a columnar target object in a circumferential direction and which fixes the cover member 14 to the tie bar 200, and the fixing member 15 may include a cover member fixation portion 151 that fixes the cover member 14 and a suppression wall 152 that suppresses movement of the stored members along the outer peripheral surface 201 of the tie bar 200.

Accordingly, the movement of the stored members along the outer peripheral surface 201 of the tie bar 200 is suppressed. Then, the cover member 14 suppresses the movement of the stored members in the radial direction of the tie bar 200. As a result, since the unintended movement of the stored members can be suppressed, it is possible to suppress the separation of the sensor 11 fixed to the tie bar 200 from the tie bar 200 due to the attractive force due to the magnetic force generated between the magnet 12 and the tie bar 200.

In addition, a gap 600 having a predetermined size may be formed between the cover member 14 fixed to the cover member fixation portion 151 and the tie bar 200.

Accordingly, for example, a cable bundle 18 extending from the sensor 11 to the outside through the gap 600 can be laid.

In addition, the cover member 14 and the fixing member 15 may have plasticity and may have the same degree of strength against an external force.

Accordingly, when an external force is applied to the cover member 14, the cover member 14 and the fixing member 15 are deformed or a dent is left in the cover member 14, depending on the magnitude of the external force. Accordingly, a worker can determine what kind of external force is applied to the cover member 14 and the fixing member 15 afterwards.

In addition, the cover member 14 may be made of non-magnetic stainless steel or resin.

Accordingly, when the cover member 14 is manufactured, a material having a small thickness and high strength can be adopted. Thus, the size of the sensor device 1 can be made compact.

In addition, the target object serving as a sensing target may be the tie bar 200 of an injection molding machine, and the sensor 11 may sense the tie bar 200.

Accordingly, even when the magnet 12 is separated from the sensor 11 as a magnetic external object approaches the sensor device 1, the stored members including the separated magnet 12 can be held inside the cover member 14. Accordingly, a state where a magnetic force is generated between the magnet 12 and the tie bar 200 can be maintained. Then, when the magnetic external object moves away from the sensor device 1, a force that causes the magnetic external object to return to its original state acts, and the state before the separation is restored. As a result, the separation of the sensor 11 fixed to the tie bar 200 from the tie bar 200 by the attractive force due to the magnetic force generated between the magnet 12 and the tie bar 200 can be suppressed.

It should be understood that the invention is not limited to the above-described embodiment, but may be modified into various forms on the basis of the spirit of the invention. Additionally, the modifications are included in the scope of the invention.

What is claimed is:

1. A sensor device comprising:
a sensor that performs sensing, the sensor being disposed between a surface of a target object, which is a magnetic metal member serving as a sensing target, and a magnet, and being fixed to the surface of the target object by an adsorption force due to a magnetic force generated between the magnet and the target object; and
a non-magnetic cover member that is fixed to the surface of the target object in a state where a plurality of members including at least the magnet and the sensor are stored inside the cover member as stored members.

2. The sensor device according to claim 1,
wherein a yoke that increases an adsorption force due to a magnetic force is fixed to the magnet, and
the cover member is disposed on the surface of the target object in a state where the stored members including at least the yoke, the magnet, and the sensor are stored inside the cover member.

3. The sensor device according to claim 2,
wherein the magnet is configured such that a length of the magnet in a center line direction is the same as a length of the sensor in the center line direction.

4. The sensor device according to claim 2,
wherein the yoke is joined to the magnet, and is configured such that a length of the yoke in a center line direction is longer than a length of the magnet in the center line direction.

5. The sensor device according to claim 4,
wherein the cover member surrounding the yoke is a non-magnetic member, and an end portion of the yoke is not in contact with or in proximity to the target object.

6. The sensor device according to claim 1,
wherein the cover member is not in contact with the stored members in a state where a magnetic force is not generated between an external object and the magnet.

7. The sensor device according to claim 6,
wherein the cover member includes five walls of which outer surfaces are configured with flat surfaces, and an opening portion.

8. The sensor device according to claim 6,
wherein, when an attractive force due to the magnetic force generated between the external object and the magnet is larger than the adsorption force, the magnet is separated from the sensor, and a part of the stored members and an inner surface of the cover member come into contact with each other, the inner surface of the cover member supports the part of the stored members,
when the attractive force is weakened, and the adsorption force due to the magnetic force generated between the magnet and the target object is larger than the attractive force, the part of the stored members is separated from the inner surface of the cover member, and
the magnet comes into contact with the sensor again by the adsorption force due to the magnetic force generated between the magnet and the target object, so that the sensor is fixed to the surface of the target object again.

9. The sensor device according to claim 1, further comprising:
a fixing member that is fixed so as to be wound around the surface of the target object, which has a columnar or tubular shape, in a circumferential direction and that fixes the cover member to the target object,
wherein the fixing member includes
a cover member fixation portion that fixes the cover member, and
a suppression wall that suppresses movement of the stored members along the surface of the target object.

10. The sensor device according to claim 9,
wherein the fixing member further includes a fixing member fixation portion for fixing the fixing member to the target object.

11. The sensor device according to claim 10,
wherein the fixing member fixation portion is formed at each of both end portions of the fixing member, and screw holes for fixing the fixing member to the target object through screws are provided to be aligned in a center line direction.

12. The sensor device according to claim 9,
wherein the suppression wall is formed to surround four sides of a region in which the stored members are disposed.

13. The sensor device according to claim 9,
wherein a predetermined size of a gap is formed between the cover member fixed to the cover member fixation portion and the target object.

14. The sensor device according to claim 9,
wherein the cover member and the fixing member have plasticity and have the same degree of strength against an external force.

15. The sensor device according to claim 1,
wherein the cover member is made of non-magnetic stainless steel or resin.

16. The sensor device according to claim 1,
wherein the target object is a tie bar of an injection molding machine, and
the sensor performs sensing of the tie bar.
